(19) United States
(12) Patent Application Publication
(10) Pub. No.: US 2025/0091592 A1
(43) Pub. Date: Mar. 20, 2025

(54) Roadway Sign for Autonomous Vehicle Sensor Calibration

(71) Applicant: Vincent Loccisano, Wellesley, MA (US)

(72) Inventor: Vincent Loccisano, Wellesley, MA (US)

(21) Appl. No.: 18/960,994

(22) Filed: Nov. 26, 2024

Related U.S. Application Data
(63) Continuation-in-part of application No. 18/441,613, filed on Feb. 14, 2024.

(51) Int. Cl. B60W 50/02; B60W 50/00; B60W 60/00; G01S 7/497; G06T 7/521; G06T 7/80; G06V 20/58

(52) U.S. Cl. CPC B60W 50/0205; G01S 7/497; G06T 7/521; G06T 7/80; G06V 20/582; B60W 2050/0083; B60W 2050/0215; B60W 60/00; B60W 2420/408; G06T 2207/10028; G06T 2207/20081; G06T 2207/30252

(57) ABSTRACT

The present invention provides a roadway sign that is visible only to computer sensors, specifically designed for calibrating autonomous vehicle sensors. The roadway sign uses low-visibility markers or calibration targets integrated into existing road infrastructure. The sign is not visible to human drivers, ensuring no distraction or confusion. A roadway sign that is invisible to the human eye but detectable by computer sensors, such as those found in autonomous vehicles, streamlines the calibration process. Continuous, reliable and frequent calibration ensures that the sensor data remains accurate, reducing the risk of misinterpretation that can lead to accidents.

### TECHNICAL FIELD

The present disclosure relates generally to devices, systems and methods for calibrating sensors in autonomous vehicles.

### BACKGROUND OF THE INVENTION

Autonomous vehicles rely on a suite of sensors, including cameras, LiDAR, and radar, to navigate and understand their surroundings. These sensors can become misaligned or degrade over time due to various factors such as physical impacts, wear and tear or changes in the environment. Precise calibration of these sensors is crucial for accurate perception and safe operation as it affects everything from obstacle detection to lane alignment and navigation.

Current calibration methods often involve using visible signs or markers, which can be distracting or even misleading to human drivers. This reliance on visible markers poses limitations in various scenarios, such as urban environments with heavy traffic or dynamic lighting conditions.

These visual markers can contribute to visual clutter on roads, potentially distracting human drivers and reducing overall road safety. In certain situations, signs may be misinterpreted by human drivers, leading to confusion and potentially dangerous situations

Autonomous vehicles can utilize advanced algorithms and machine learning techniques to self-calibrate their sensors based on environmental cues. Although this eliminates the need for visible signs it is prone to error as vehicles must adapt their sensor calibration in real-time based on changing environmental conditions, such as weather or lighting, in order to ensure optimal performance under various circumstances.

LiDAR-based sensors are the primary sensors used in AV technology. LiDAR involves the irradiation of a laser, with near-infrared wavelengths, thousands of times per second onto an object. It then detects the reflected light and, based on the time measurement, determines the distance to the object with high resolution and accuracy. LiDAR works in the dark and is more robust than a vision sensor as it works in rain, snow and fog and is effective at identifying geometry of three-dimensional objects and is able to accurately measure the distance to an object. LIDAR and infrared cameras rely on specific wavelengths of light to perceive their surroundings. Materials that reflect these wavelengths are crucial for ensuring accurate detection. LIDAR systems emit and detect near-infrared light, so surfaces that strongly reflect this wavelength, like titanium dioxide-based paints, are highly visible to these sensors.

LiDAR sensor calibration is accomplished by target-based calibration and self-calibration. Target-based calibration involves a checkerboard pattern placed in the sensor's field of view. By detecting and analyzing the pattern's features, the sensor's intrinsic and extrinsic parameters can be estimated. In another example, spherical targets are used to establish precise 3D reference points. The LiDAR sensor's measurements are compared to the known positions of these spheres to refine the calibration. Self-calibration involves the use of motion-based calibration and feature-based calibration.

### SUMMARY OF THE INVENTION

The present invention provides a roadway sign that is visible only to computer sensors, specifically designed for calibrating autonomous vehicle sensors. The roadway sign uses low-visibility markers or calibration targets integrated into existing road infrastructure. The sign is not visible to human drivers, ensuring no distraction or confusion. A roadway sign that is invisible to the human eye but detectable by computer sensors, such as those found in autonomous vehicles, streamlines the calibration process. Continuous, reliable and frequent calibration ensures that the sensor data remains accurate, reducing the risk of misinterpretation that can lead to accidents.

In some embodiments specialized materials are used that reflect specific wavelengths of light, invisible to the human eye but detectable by the sensors of autonomous vehicles e.g., LiDAR, infrared sensors and the like. Other embodiments employ advanced optical techniques, such as structural light patterns or infrared markers that are only visible to computer vision systems. In an example embodiment a checkerboard occupies the background of an existing road sign.

A method of the embodiment involves the calibration of LiDAR sensors using a grid pattern on a roadway sign that is visible to the LiDAR sensors and not visible to humans. LiDAR sensors are calibrated using a grid pattern to establish a precise geometric relationship between the sensor's internal components and its external environment. The grid pattern that may be made up of materials that are visible to the LiDAR sensors and not visible to the human eye. LiDAR sensors recognize a calibration target, often a checkerboard pattern or grid of known dimensions, when the target is within the LiDAR sensor's field of view. The LiDAR sensor scans the target, generating a point cloud of the grid's corners. By comparing the measured distances and angles of these points to their known positions, the sensor's intrinsic and extrinsic parameters can be accurately determined. intrinsic parameters, such as focal length and principal point describe the sensor's internal characteristics. Extrinsic parameters, including rotation and translation, define the sensor's position and orientation relative to the target. This calibration process ensures that the liDAR sensor can accurately perceive the 3D world and generate reliable point cloud data for autonomous vehicle navigation and obstacle detection.

The precise and controlled nature of the signage allows for accurate calibration of autonomous vehicle sensors, enhancing their overall performance. The embodiment eliminates the need for traditional, visually distracting, calibration markers and reduces the potential for accidents caused by confusing and cluttered signage. The unobtrusive nature of the signage ensures that it does not disrupt the driving experience for human drivers.

### BRIEF DESCRIPTION OF DRAWINGS

FIG. 1 is an illustration of a road sign with calibration pattern on an existing road sign.

FIG. 2 is an illustration of a calibration pattern integrated with a road sign structure.

FIG. 3 is a diagram of a method of the disclosure.

### DETAILED DESCRIPTION

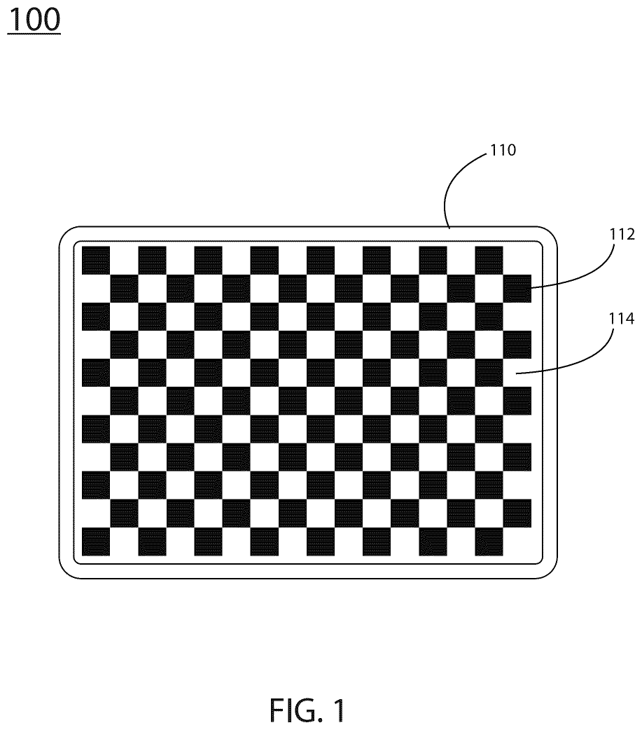

FIG. 1 illustrates a commonly used checkerboard pattern 110 including black squares 112 and white squares 114. The pattern is specifically designed to calibrate a LiDAR sensor.

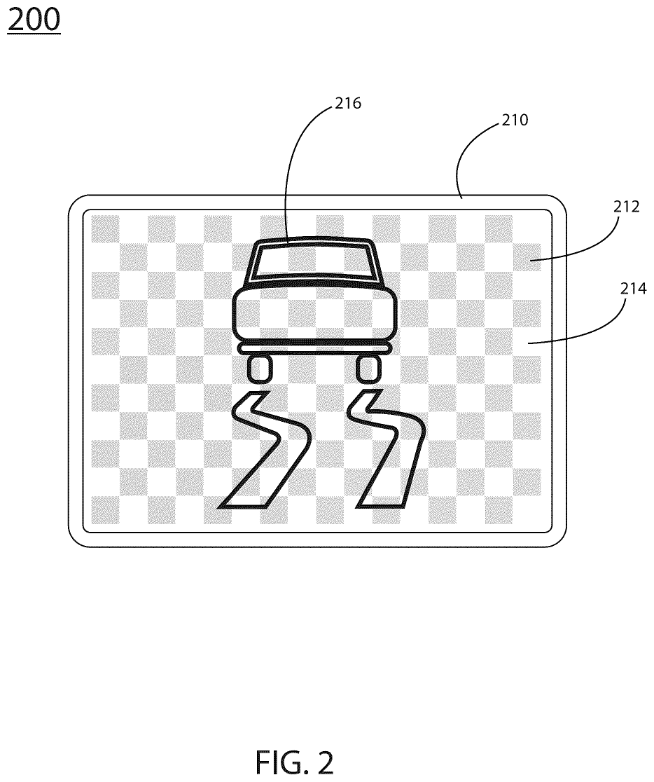

FIG. 2, illustrates a checkerboard pattern 200 in the background of an existing road sign 216. A first set of squares 212 in the checkerboard are coated with titanium-oxide based paint while a second set of squares 214 in the checkerboard pattern are a less reflective paint of a similar color. In other embodiments the checkerboard is made up of titanium-oxide based paint and a paint of a different color, for example yellow and white squares may make up a background that is not distracting to a driver reading the road sign 216 but is visible to a LiDAR sensor.

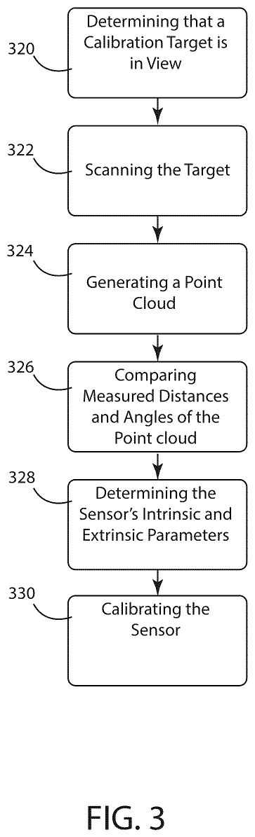

FIG. 3 illustrates a method for using the embodiment of FIG. 2. A target 210 enters the sensor's field of view 320 wherein the sensor scans 322 the target. A target is commonly a checkerboard pattern made up of a first set of squares 212 and a second set of squares 214. The method continues by generating a point cloud 324 of the pattern's corners. The method continues by comparing 326 the measured distances and angles of these points to their known positions and determining the sensor's intrinsic and extrinsic parameters 328. Finally the method concludes by calibrating the autonomous vehicle sensor 330.

1. A roadway sign comprising:
materials that reflect specific wavelengths of light detectable by autonomous vehicle sensors for use in calibration of said sensors.

2. The roadway sign of claim 1 wherein:
said material is titanium dioxide-based paint.

3. The roadway sign of claim 1 further comprising
a pattern recognizable by machine learning algorithms; wherein
the pattern is not recognizable to the human eye.

4. The roadway sign of claim 3 wherein:
the pattern is a checkerboard having a first set of squares alternating with a second set of squares;
the first set of squares in the checkerboard coated in titanium dioxide-based paint; and
the second set of squares coated in a non-reflective paint.

5. The roadway sign of claim 3 further comprising:
an image visible to a human superimposed over said pattern recognizable by machine learning algorithms.

6. A method for calibrating autonomous vehicle sensors using the sign of claim 1, the method comprising:
determining that by autonomous vehicle sensor, that a roadway sign target is in view; and
scanning the target; and
generating a point cloud; and
comparing measured distances and angles of the point cloud; and
determining the sensor's intrinsic and extrinsic parameters; and
calibrating the sensor.
